(19) United States
(12) Patent Application Publication
(10) Pub. No.: US 2017/0076243 A1
(43) Pub. Date: Mar. 16, 2017

(54) PROFILE SEARCHING AND MATCHING SYSTEM

(71) Applicant: NEUDESIC, LLC, Irvine, CA (US)

(72) Inventors: Jason Noble, Huntington Beach, CA (US); Parsa Rohani, Laguna Beach, CA (US)

(73) Assignee: NEUDESIC, LLC, Irvine, CA (US)

(21) Appl. No.: 14/855,104

(22) Filed: Sep. 15, 2015

(51) Int. Cl. G06Q 10/06; G06F 17/30

(52) U.S. Cl. CPC G06Q 10/063112; G06F 17/30528

(57) ABSTRACT

A system and method for searching electronic profile data of people or other entities in an organization, and identifying people whose profiles have selected values associated with selected fields matching the corresponding selected values and fields of an anchor profile for the purpose of discovering commonalities between profiles.

### FIELD OF THE INVENTION

The present invention relates generally to searching electronic profile data of people in n organization. More specifically, the present invention relates to identifying people whose profiles have selected values associated with selected fields of their profiles, matching the corresponding selected values and fields of an anchor profile.

### BACKGROUND OF THE INVENTION

Most organizations have employees, contractors, experts, and other human resources available with specific attributes, such as qualifications, talents, skills, backgrounds, experience, locations, authority, connections, etc. However, most organizations are unable to quickly and efficiently identify such resources upon request. There is thus a need for a system that allows a searcher to quickly and efficiently identify such people in the organization as needed for a specific task (e.g., project, case, matter, or one-time task), based on values associated with selected fields of profiles associated with the available people. There is a more particular need for a system that does so by allowing the searcher to select the search criteria based on values of fields associated with an anchor profile.

### SUMMARY OF THE INVENTION

The present invention allows a searcher to search through electronic profiles of people by selecting fields (referred to herein as “anchor fields”) of a selected profile (referred to herein as an “anchor” profile), and in response be presented with other profiles (referred to herein as “matching profiles”) having matching values in their corresponding fields. This allows the searcher to quickly identify the right people to effectively tackle a specific task, If the anchor fields (and search criteria associated therewith) are changed, the matching profiles are correspondingly updated and presented accordingly. Further, the searcher may conduct searches based on serially selecting anchor fields between multiple searches, or by selecting multiple anchor fields in parallel for a single search. For serial searches, the anchor fields may be from the same anchor profile, or from different anchor profiles. For example, the second search in a serial search may key off an anchor field from one of the matching profiles from the first search.

This method of searching is referred to herein as “pivoting,” because the search criteria is anchored to values of fields of one or more profiles, and the matching profiles are then identified based on the anchor values. The matching profiles are thus determined by “pivoting” off of the anchor profiles, and in certain embodiments may be accessed by pivoting from one profile to the next, as illustrated in FIG. 4. The searcher may also search through electronic profiles of people by selecting values for specific fields in a profile template, such that the template serves as an anchor profile.

In accordance with one aspect of the present invention, a method of identifying people in an organization includes providing a database of personal profiles (i.e., each profile is associated with a corresponding person, referred to herein as the profile “'owner”), each profile having common data fields having corresponding data associated therewith, receiving a request to have one of the profiles serve as an anchor profile, receiving a request to have one of the common data fields of the anchor profile serve as an anchor field, receiving a request to identify which of the other profiles have data in their corresponding anchor fields matching the data associated with the anchor field of the anchor profile, identifying such profiles, and returning a list of such profiles. The profiles are referred to herein as “personal profiles” because they are associated with people. Each “personal profile” may be associated with an individual person, or may be associated with an organization, team, or other group of people. Although the examples described and illustrated herein use profiles of individuals, all such profiles (including those of groups) are referred to herein as “personal profiles.”

In another aspect of the invention, the method further includes receiving a request to have another of the common data fields of the anchor profile serve as a second anchor field, receiving a request to identify which of the other profiles have data in their corresponding anchor fields matching the data associated with the second anchor field of the anchor profile, identifying such profiles, and returning a list of the profiles having data in their corresponding anchor fields matching 1) the data associated with the first anchor field of the anchor profile and the data associated with the second anchor field of the anchor profile, or 2) the data associated with the first anchor field of the anchor profile or the data associated with the second anchor field of the anchor profile.

In another aspect of the invention, a method of identifying people in an organization includes providing a database as previously described, receiving a first request to have a first one of the profiles serve as a first anchor profile, receiving a second request to have a first one of the common data fields of the first anchor profile serve as a first anchor field, receiving a third request to identify which of the other profiles have data in theft corresponding anchor fields matching the data associated with the first anchor field of the first anchor profile, identifying which of the profiles have data in their corresponding anchor fields matching the data associated with the first anchor field of the first anchor profile, returning a first list of the identified profiles (including a second profile), then after returning the first list, a) receiving a fourth request to have the second profile serve as a second anchor profile, b) receiving a fifth request to have a second one of the common data fields of the second anchor profile serve as a second anchor field, c) receiving a sixth request to identify which of the profiles of the first list have data in their corresponding anchor fields matching the data associated with the second anchor field of the second anchor profile, d) identifying which of the profiles in the first list have such data, and e) returning a second list of the profiles in the first list identified as having such data in their corresponding anchor fields.

In another aspect of the invention, any or all of the requests are received substantially simultaneously from a single input action.

In another aspect of the invention, the list includes links to the profiles, on-line indicators indicating if the owners are then presently on-line, and ethical-wall indicators indicating whether the owner is the subject of any ethical walls set up by the firm.

### BRIEF DESCRIPTION OF THE DRAWINGS

The foregoing and other aspects of various embodiments of the invention are described in further detail with reference to the accompanying drawings, wherein:

FIG. 1 is a flowchart illustrating a method of the present invention;

FIG. 2 illustrates a sample layout of a sample profile with sample data fields in accordance with certain embodiments of the present invention;

FIG. 3A shows the profile of FIG. 2 serving as an anchor profile, with one data field expanded and selected to serve as an anchor field;

FIG. 3B shows the profile of FIG. 3A, with an additional data field expanded and selected to serve as an anchor field;

FIG. 4 shows marching profiles identified based on the values associated with the selected fields in the anchor profile of FIG. 3B; and

FIG. 5 shows a sample layout of a list of matching profiles presented in accordance with an embodiment of the present invention.

### DETAILED DESCRIPTION OF THE EMBODIMENTS

The present invention relates to a system and method for searching electronic profile data of people in an organization, and identifying people whose profiles have selected values associated with selected fields matching the corresponding selected values and fields of an anchor profile. A typical use of the invention would be as an experience discovery system, to accelerate knowledge management and marketing efforts for law firms and legal departments.

Searching profiles as described herein helps decrease the time it takes to locate the right people with the right experience, skills or relationships required to take on a particular project. For example, a searcher could identify a list of people with shared or similar criteria, like education, bar admissions, or judge clerkships, and then navigate quickly through their profiles. The invention is typically embodied in software, running on a secured server, and accessible via stand-alone or network connections, including mobile applications.

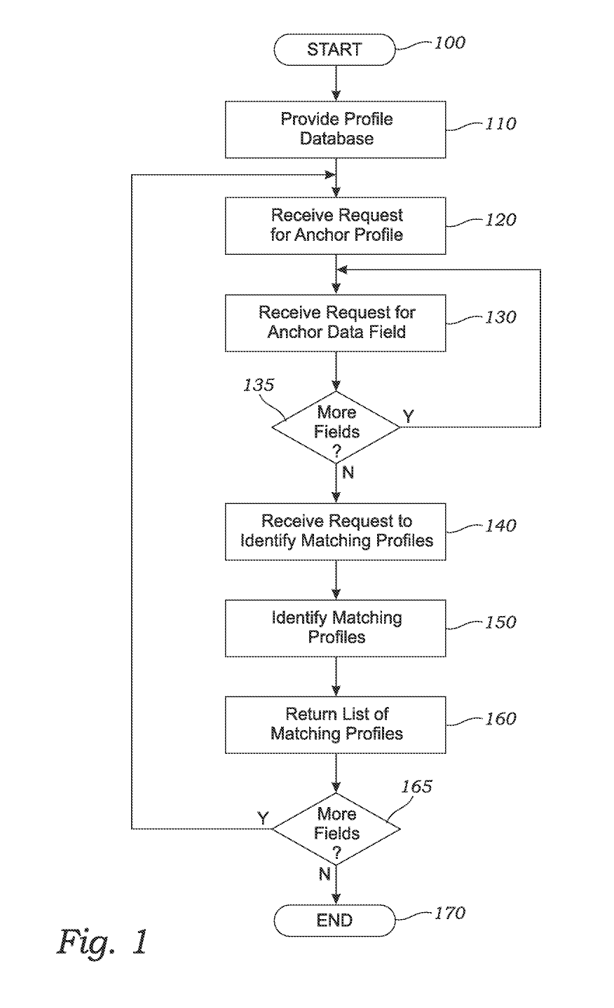

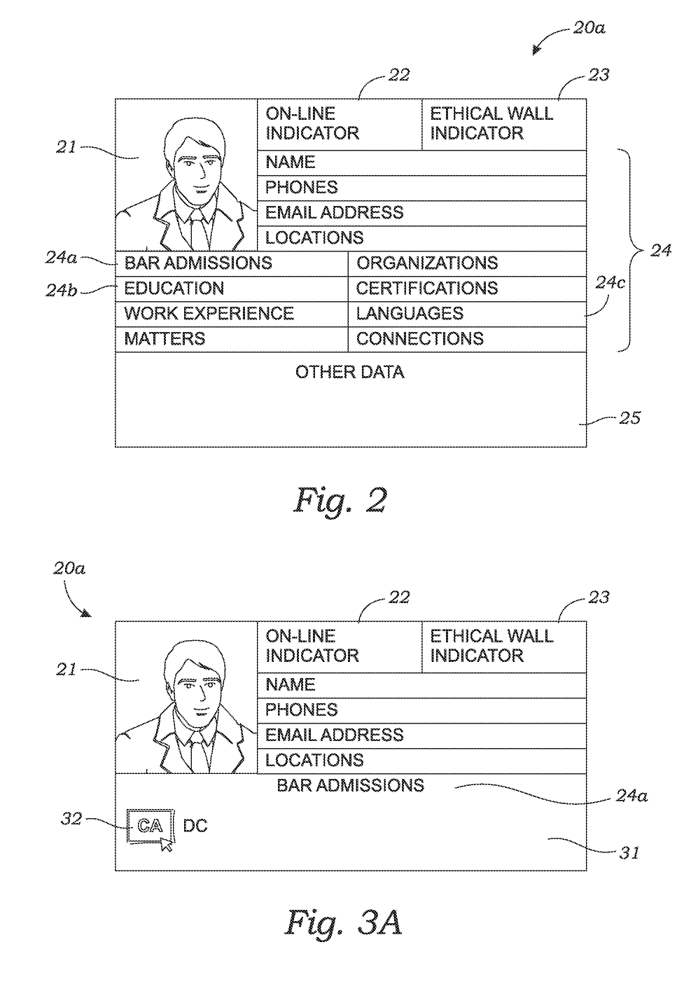

Turning now to FIG. 1, a flowchart is shown illustrating a method of identifying people in an organization, in accordance with the present invention. The method begins at Step 100. At Step 110, a database of personal profiles is provided. This may include situations of actual development of a database, purchase of a database, or simply that the database is available for use. The database of profiles includes profiles of people within (i.e., available to) the organization, including, e.g., employees, officers, directors, contractors, volunteers, experts, etc. Associated with each of the profiles are data fields, as is known in the art. Some sample data fields 24 are shown in FIG. 2, and include bar admissions 24a, education 24b, work experience, organizations, certifications, languages 24c, connections, and matters. Another common data field may be a photo slot 21 as shown in FIG. 2. Other data 25 is shown to represent that the data fields may be predetermined, programmable, customized, or any combination thereof, and that although profiles typically have most if not all data fields in common with each other, profiles may also have unique data fields not common to all other profiles. For the examples described herein, data fields 24 will be considered common data fields, i.e., all of the profiles at issue will have these fields.

Each of the common data fields 24 for each of the profiles has corresponding data associated therewith. In other words, each profile has data in the “name,” “phones,” “email address,” “locations,” “bar admissions,” “education,” and other common data fields 24. The data may be blank or null, or may be stored in any format as is known in the art. Similarly, the data may be searchable/selectable using methods known in the art, such as pull-down menus, spring menus, rotary menus, radio button selection menus, free-form, pop-up menus, etc.

With the database in existence, the method continues to Step 120, where a request is received to begin a search. The request includes selecting a particular one of the profiles to serve an as anchor profile, which means the values of selected fields in this profile will be used to find other profiles with matching values in those same fields. Selection of the anchor profile may be by any suitable means, including the searcher clicking on the profile with a mouse action, touching the profile on a touch pad, selecting the profile from any of various menus, etc. Similarly, the searcher may perform select the anchor profile by selecting data associated with the selected profile, such as by clicking on a name in a list of names, or a photo in a series of photos, where the names or photos are linked to the respective profiles.

With the anchor profile selected, the method continues to Step 130, where a request is received for a common data field of the anchor profile to serve as the anchor data field. The anchor data field is the data field which will be searched in the other profiles to see if the data in that field of the other profiles match the data in the anchor field of the anchor profile. Selection of the anchor field may be by any suitable means. Multiple anchor data fields may be selected. This is illustrated at Step 135, where the query is whether any more anchor fields should be used in the search. If the answer is YES, the method loops back to Step 130 to receive an additional request for another data field to serve as an anchor data field. The loop continues until the answer to the query at Step 135 is NO.

With the anchor profile selected, and the anchor data fields selected, the method continues to Step 140, where a request is received to identify matching profiles. In other words, the request is for the search to identify profiles with data in their data fields that matches the data in the corresponding anchor data fields of the anchor profile. In one embodiment, data in a data field of a profile being searched is considered “matching data” only if the data includes the same data in the corresponding anchor field of the anchor profile. For example, if the data in the anchor field “bar admissions” of the anchor profile is “CA,” and if a profile being searched includes “CA” in its “bar admissions” data field, then that profile would be returned as having matched. In another embodiment, the “matching data” must literally match byte-for-byte the same data in the corresponding anchor field of the anchor profile. In another embodiment, “matching data” must only match any portion of the data in the corresponding anchor field of the anchor profile.

In another embodiment, “matching data” is data that satisfies a Boolean expression executed on multiple anchor data fields. For example, a searcher may be searching for any lawyers in the organization who are admitted to the Bar in California, and who also speak French. Such a Boolean expression might be paraphrased as “bar admission includes CA, and languages includes FRENCH.” All profiles with at least “CA” in the “bar admissions” data field, and at least “French” in the “languages” data field, would be returned as matching. In another example, a searcher may be searching for any lawyers in the organization who are admitted to the Bar in California, or who speak French. Such a Boolean expression might be paraphrased as “bar admission includes CA, or languages includes FRENCH.” All profiles with at least “CA” in the “bar admissions” data field, or at least “French” in the “languages” data field, would be returned as matching.

In another embodiment, “matching data” is data that satisfies a Boolean expression executed on multiple data values in a single anchor data field. For example, a searcher may be searching for any lawyers in the organization who are admitted to the Bar in California and Washington. Such a Boolean expression might be paraphrased as “bar admission includes CA, and bar admission includes Washington.” All profiles with at least “CA” and “WA” in the “bar admissions” data field would be returned as matching.

Various other Boolean expressions and operations may be available depending on the design of systems embodying the invention, and such expressions and capability may be programmed as is known in the art. Thus, as used herein, “matching” refers to matching the search criteria based on data in the anchor data fields of the anchor profile. The search criteria may be simply to literally match the data in the anchor data fields of the anchor profile, but the search criteria may also be more complicated as discussed above.

Selection of the anchor profile (Step 120) and the anchor fields (Step 130) may be requested substantially simultaneously, for example with a single selection action such as highlighting selected anchor fields in an anchor profile. Similarly, the request to identify matching profiles (Step 140) may occur substantially simultaneously with one or more of Steps 120 and 130, for example, with a single selection action such as after highlighting selected anchor fields in an anchor profile, and selecting the search criteria associated with such anchor fields, activating a “search” button which activates all three requests. Such single selection action may likewise activate more than three requests. For example, in an embodiment where multiple anchor data fields are to be used in an initial search, the single selection action could include the request at Step 120, multiple requests at Step 130, and the request at Step 140.

Once the requests at Steps 120, 130, and 140 are received (separately or substantially simultaneously), the method continues to Step 150 where the matching profiles are identified. As previously discussed, this is identifying which of the profiles being searched have data in their data fields matching the data in the corresponding anchor field(s) of the anchor profile, i.e., which profiles match the search criteria based on data in the anchor data fields of the anchor profile,

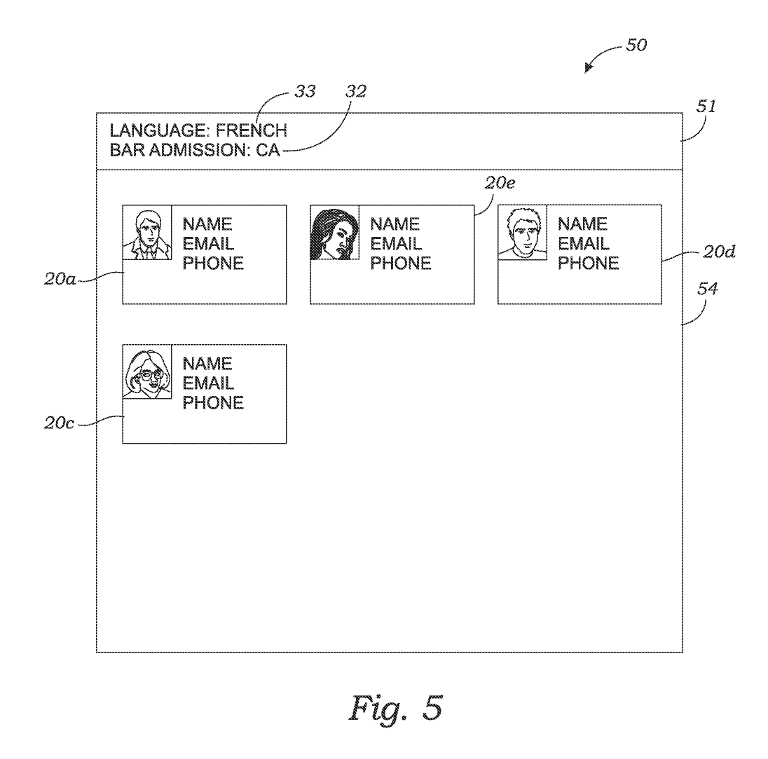

Once the matching profiles are identified, the method proceeds to Step 160 where a list of the matching profiles is returned. Returning the list may comprise returning an electronic list to a software routine for further processing, printing the list to a printer or PDF file, and/or displaying the list on an output device such as a display. In the latter case, the list may consist of simply a list of names or other summary data, and/or may include thumbnails or summary profile data. For example, as shown in FIG. 5, the list may be displayed as a series of summary data including headshots, name, email address, and phone numbers. One or more of the fields may comprise active links, such as, e.g., to expand the selected profile, launch an email program, or dial the person by phone, Skype, etc. The list may also include the original anchor profile, either separately set out (e.g., by position, color, size, etc.), or mixed in un-emphasized with the other matching profiles.

Still referring to FIG. 1, once a list of matching profiles (with or without the anchor profile) is returned (e.g., to a display as shown in FIG. 5), the searcher may want to refine the search to drill-down to a more specific list of people. This is represented in FIG. 1 at Step 165, where the inquiry is whether the searcher would like to select additional anchor fields or edit search criteria from the previous anchor fields. If the answer is NO, the process ends. If the answer is YES, the process loops back to Step 120 where the searcher may then conduct a second search limited to the profiles returned. In the second search, the searcher may continue to key the search criteria off the first anchor profile (Step 120) and anchor fields (Step 130) for a more refined search within the list of returned profiles. The searcher may instead select a second anchor profile from the matching profiles (Step 120) other than the original anchor profile, and then select new or the same anchor fields (Step 130). Either way, the searcher may select new search criteria (Step 140), such as simple literal matching, or Boolean expressions, as previously discussed.

In the case where the searcher selects a second anchor profile from the matching profiles (Step 120), and selects anchor fields from the second anchor profile (Step 130), the request for matching profiles (Step 140) will result in identification (Step 150) and return (Step 160) of a list of profiles matching the data associated with the anchor fields of the second anchor profile. Since the second search is limited to the profiles returned from the first search, the list of profiles identified and returned will consist of only those profiles that match 1) the first search criteria keyed off values in the selected anchor fields of the first anchor profile, and 2) the second search criteria keyed off values in the selected anchor fields of the second anchor profile. In one embodiment, the second list is returned as a new display of the matching profiles. In another embodiment, the list is returned as a display of all the profiles matching the first search criteria, but with the profiles matching the second criteria emphasized or set apart. For example, the profiles matching the second criteria may have a visual indicator such as a colored icon in close proximity, or they may have a different background color, or they may be enlarged, or visually rearranged. Or those profiles not matching the second search criteria may be grayed out, or have an X over a portion of the profile, or have a portion of the profile concealed such as by a graphic of a folded page. These are just some examples of possible display options for the list of profiles matching both the first and second search criteria.

Turning now to FIG. 2, a sample layout of a sample profile 20a from a law firm is shown in accordance with embodiments of the present invention, with sample data fields 21 22, 23, 24, 25. As previously mentioned, the data fields may vary and may include more or less than shown in the examples. The data fields in FIG. 2 include common data fields 24, and optionally other data 25 that may be optional or even unique to specific profiles. The data may be stored and/or displayed in any manner. Typically, the data fields include a headshot 21 or other icon representing the owner of the profile. The data fields may also include status flags or special indicators (not shown), such as “vacation,” “away-from-desk,” “in-meeting,” “looking-for-work,” “same-office,” etc. The indicators may include active links to additional data associated therewith. indicators may be represented as on/off (or true/false, or yes/no, etc.) based on colored buttons, flags, highlighted fields, motion icons, or any other visual cue.

An “on-line” indicator 22 indicates if the owner is currently on-line (e.g., accessible via a common network). An “ethical wall” indicator 23 indicates if the owner is blocked from certain work based on an ethical wall implemented by the law firm. This indicator 23 may contain an active link tied to more detailed data as to the projects from which the owner is walled off. Other typical data fields are basic contact information such as name, phones, email addresses, and locations. The phones and email address data fields may contain active links for directly contacting the owner.

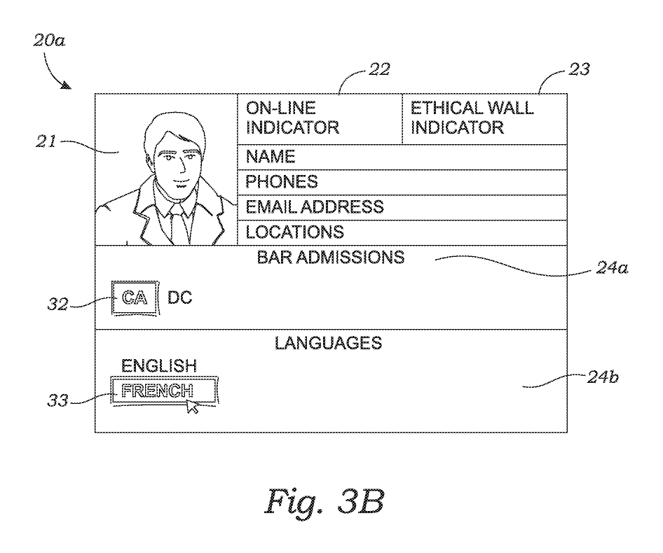

Additional fields shown in FIG. 2 are bar admissions 24a, education 24b, languages 24c, organizations, certifications, connections, work experience, and matters (e.g., projects, the owner is actively working on, has worked on, etc.). Selection of a data field may expand or open up the field exposing the data associated therewith. For example, selection of the bar admissions field 24a in FIG. 2 may result in expansion of the field to a larger area 31 as seen in FIG. 3A. In this example, the data indicates the owner is admitted to the state bars in California (CA) 32 and Washington, D.C. (DC). Selection of the languages field 24b of the profile 20a in FIG. 3A results in an expansion of that field as well, as seen in FIG. 3B. In this example, the data indicates the owner speaks French 33 and English.

A specific search example will now be described. Although simple searching is possible as is known in the art of database searching, the example here is based on pivoting off an already-identified profile. The searcher in this example is looking for people with profile data similar to certain profile data of the profile in FIG. 3B, specifically, people in the organization admitted to the California state bar, and who speak French. In other words, profile 20a is the anchor profile, and the common data fields “bar admissions” 24a and “languages” 24b are the anchor data fields. The search criteria is to find profiles with data in those corresponding fields that have values of “CA” in the “bar admissions” field 24a (as indicated by the selected “CA” 32), and “French” in the “languages” field 24b (as indicated by the selected “French” 33).

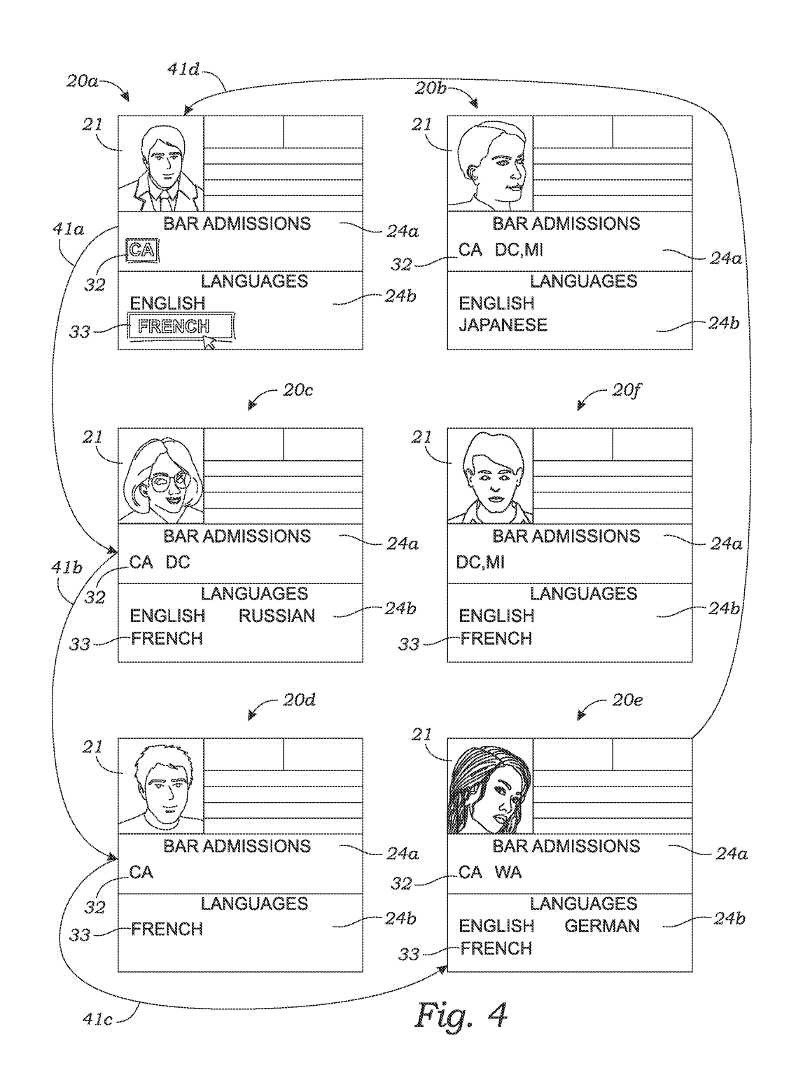

The database in this example includes at least profiles 20a, 20b, 20c, 20d, 20e, and 20f, as shown in FIG. 4. The searcher selects profile 20a to serve as the anchor profile (Step 120 of FIG. 1). This may be done by simply clicking on the profile 20a. The searcher then selects the anchor data fields 24a and 24b (Step 130 of FIG. 1), by clicking on them within the anchor profile 20a. The searcher then selects the search criteria by clicking on the specific values of the anchor data fields 24a and 24b, i.e., “CA” 32 and “French” 33. The system interface may include other options (not shown) for setting up Boolean expressions or other search criteria. Once the anchor profile, anchor fields, and search criteria are selected, the searcher then initiates the search/pivot (Step 140 of FIG. 1) by activating a search/pivot button, icon, link, etc. (not shown).

The matching profiles are then identified (Step 150 of FIG. 1), and returned (Step 160 of FIG. 1). As seen in FIG. 4, the profiles identified would include profiles 20c, 20d, and 20e, all of which include both “CA” 32 in the “bar admissions” field 24a, and “French” 33 in the “languages” field 24b, but would not include profiles 20b (has “CA” bar admission but does not have “French” language) and 20f (has “French” language but does not have “CA” bar admission). In one embodiment, the searcher could then pivot through the anchor profile 20a and identified profiles 20c, 20d, and 20e, as represented by pivot arrows 41a, 41b, 41c, and 41d. During the pivot process, the searcher may select any of the profiles for further review, and/or to serve as a second anchor profile as previously described herein. Selection could be done by clicking, scrolling, tapping, or any other action as is known in the art. In some embodiments, the search results are preserved, so after review of one profile, the searcher may return back to the original display screen for continued pivoting with the originally-identified and returned profiles.

A sample display layout 50 of the list of matching profiles is shown in FIG. 5. The layout includes an upper area 51 for displaying the search criteria, and a lower area 54 for displaying anchor profile 20a and matching profiles 20c, 20d, and 20e. In this example, the search criteria is that “language” includes “French” 33 and “bar admissions” includes “CA” 32. In this layout, the searcher may select any of the profiles for further review after viewing a first one of the profiles, by, e.g., clicking on the desired profile, without having to pivot sequentially through the profiles as indicated by pivot arrows 41a, 41b, 41c, and 41d in FIG. 4.

Other embodiments include additional features. For example, non-anchor fields (or data therein) in the matching profiles may be highlighted if they have data that matches the data in the corresponding non-anchor fields of the anchor profile. Although particular embodiments of the present invention have been shown and described, the present invention should not be limited to the preferred embodiments, and it will be apparent to those skilled in the art that various changes and modifications may be made without departing from the spirit and scope of the present invention. Thus, the present invention is intended to cover alternatives, modifications, and equivalents, which may be included within the spirit and scope of the present invention as defined by the claims.

What is claimed is:

1. A method of identifying people in an organization, comprising:
providing a database of personal profiles, each of the profiles having common data fields, each of the common data fields for each of the profiles having corresponding data associated therewith;
receiving a first request to have a first one of the profiles serve as a first anchor profile;
receiving a second request to have a first one of the common data fields of the first anchor profile serve as a first anchor field;
receiving a third request to identify which of the profiles have data in their corresponding anchor fields matching the data associated with the first anchor field of the first anchor profile;
identifying which of the profiles have data in their corresponding anchor fields matching the data associated with the first anchor field of the first anchor profile; and
returning a list of the identified profiles.

2. The method of claim 1, wherein the first, second, and third requests are received substantially simultaneously from a single input action.

3. The method of claim 1, further comprising:
receiving a fourth request to have a second one of the common data fields of the first anchor profile serve as a second anchor field;
receiving a fifth request to identify which of the profiles have data in their corresponding anchor fields matching the data associated with the second anchor field of the first anchor profile;
identifying which of the profiles have data in their corresponding anchor fields matching the data associated with the second anchor field of the first anchor profile; and
returning a second list of the profiles identified as having data in their corresponding anchor fields matching the data associated with the first anchor field of the first anchor profile and the second anchor field of the first anchor profile.

4. The method of claim 3, wherein the fourth and fifth requests are received substantially simultaneously from a single input action.

5. The method of claim 1, further comprising:
receiving a fourth request to have a second one of the common data fields of the first anchor profile serve as a second anchor field;
receiving a fifth request to identify which of the profiles have data in their corresponding anchor fields matching the data associated with the second anchor field of the first anchor profile;
identifying which of the profiles have data in their corresponding anchor fields matching the data associated with the second anchor field of the first anchor profile; and
returning a second list of the profiles identified as having data in their corresponding anchor fields matching the data associated with the first anchor field of the first anchor profile or the second anchor field of the first anchor profile.

6. The method of claim 5, wherein the fourth and fifth requests are received substantially simultaneously from a single input action.

7. The method of claim 1, wherein for each of the profiles in the list, the list includes corresponding data selected from the group consisting of a link to the corresponding profile, an on-line indicator, and an ethical-wall indicator.

8. A method of identifying people in an organization, comprising:
providing a database of personal profiles, each of the profiles having common data fields, each of the common data fields for each of the profiles having corresponding data associated therewith;
receiving a first request to have a first one of the profiles serve as a first anchor profile;
receiving a second request to have a first one of the common data fields of the first anchor profile serve as a first anchor field;
receiving a third request to have a second one of the common data fields of the first anchor profile serve as a second anchor field;
receiving a fourth request to identify which of the profiles have data in their corresponding anchor fields matching the data associated with the first anchor field of the first anchor profile;
receiving a fifth request to identify which of the profiles have data in their corresponding anchor fields matching the data associated with the second anchor field of the first anchor profile;
identifying which of the profiles have data in their corresponding anchor fields matching the data associated with the first anchor field of the first anchor profile, and matching the data associated with the second anchor field of the second anchor profile; and
returning a list of the profiles identified as having data in their corresponding anchor fields matching the data associated with the first anchor field of the first anchor profile, and matching the data associated with the second anchor field of the first anchor profile.

9. The method of claim 8, wherein the fourth and fifth requests are received substantially simultaneously from a single input action.

10. The method of claim 9, wherein the first, second, third, fourth and fifth requests are received substantially simultaneously from a single input action.

11. The method of claim 8, wherein for each of the profiles in the list, the list includes corresponding data selected from the group consisting of a link to the corresponding profile, an on-line indicator, and an ethical-wall indicator.

12. A method of identifying people in an organization, comprising:
providing a database of personal profiles, each of the profiles having common data fields, each of the common data fields for each of the profiles having corresponding data associated therewith;
receiving a first request to have a first one of the profiles serve as a first anchor profile;
receiving a second request to have a first one of the common data fields of the first anchor profile serve as a first anchor field;
receiving a third request to identify which of the profiles have data in their corresponding anchor fields matching the data associated with the first anchor field of the first anchor profile;
identifying which of the profiles have data in their corresponding anchor fields matching the data associated with the first anchor field of the first anchor profile;
returning a first list of the identified profiles, the first list including a second profile;
after returning the first list, receiving a fourth request to have the second profile serve as a second anchor profile;
after returning the first list, receiving a fifth request to have a second one of the common data fields of the second anchor profile serve as a second anchor field;
after returning the first list, receiving a sixth request to identify which of the profiles of the first list have data in their corresponding anchor fields matching the data associated with the second anchor field of the second anchor profile;
identifying which of the profiles in the first list have data in their corresponding anchor fields matching the data associated with the second anchor field of the second anchor profile; and
returning a second list of the profiles in the first list identified as having data in their corresponding anchor fields matching the data associated with the second anchor field of the second anchor profile.

13. The method of claim 12, wherein the first, second, and third requests are received substantially simultaneously from a single input action.

14. The method of claim 13, wherein the fourth, fifth, and sixth requests are received substantially simultaneously from a single input action.

15. The method of claim 12, wherein the fourth, fifth, and sixth requests are received substantially simultaneously from a single input action.

16. The method of claim 12, wherein for each of the profiles in the first list, the first list includes corresponding data selected from the group consisting of a link to the corresponding profile, an on-line indicator, and an ethical-wall indicator.

17. The method of claim 12, wherein for each of the profiles in the second list, the second list includes corresponding data selected from the group consisting of a link to the corresponding profile, an on-line indicator, and an ethical-wall indicator.
